(19) United States
(12) Patent Application Publication
(10) Pub. No.: US 2009/0320373 A1
(43) Pub. Date: Dec. 31, 2009

(54) Crash-Resistant Gate System and Method

(75) Inventor: John F. Payne, Ennis, TX (US)

Correspondence Address: BAKER BOTTS L.L.P., 2001 ROSS AVENUE, SUITE 600, DALLAS, TX, 75201-2980, US

(73) Assignee: Payne Fence Products, LLC, Ennis, TX (US)

(21) Appl. No.: 12/495,647

(22) Filed: Jun. 30, 2009

Related U.S. Application Data
(60) Provisional application No. 61/076,872, filed on Jun. 30, 2008.

(51) Int. Cl. E06B 9/01; E06B 9/00

(52) U.S. Cl. 49/50; 49/506

(57) ABSTRACT

In certain embodiments, a crash-resistant gate system includes a gate panel including a first crash beam member. The system further includes a first post including a first roller-hub assembly and a second post including a second roller-hub assembly. The first and second roller-hub assemblies engage the first crash beam member such that the first and second roller-hub assemblies provide cantilever support for the gate panel.

### RELATED APPLICATIONS

This application claims the benefit under 35 U.S.C. §119(e) of the priority of U.S. Provisional Application No. 61/076,872, filed Jun. 30, 2008, entitled “Crash Resistant Gate for Fence System and Method Therefor.”

### TECHNICAL FIELD

This invention relates generally to fence systems and more particularly to a crash-resistant gate system and method.

### BACKGROUND

It is often desirable or even necessary to prevent certain individuals from crossing a boundary (e.g., a perimeter of privately-owned real estate or another key asset) while allowing certain other individuals to cross the boundary. Free-standing fences (e.g., chain link fencing and barbed wire fencing) may include integrated gates such that certain individuals and/or vehicles may be prevented from crossing a boundary (i.e., when the gate is closed) while certain other individuals and/or vehicles may be allowed to cross the boundary (i.e., when the gate is open). Conventional gates may include, for example, a gate panel supported by a gate track positioned along the ground, the gate panel riding on the track such that the gate panel may be opened and closed.

### SUMMARY

According to embodiments of the present invention, disadvantages and problems associated with previous gate systems may be reduced or eliminated.

In certain embodiments, a crash-resistant gate system includes a gate panel including a first crash beam member. The system further includes a first post including a first roller-hub assembly and a second post including a second roller-hub assembly. The first and second roller-hub assemblies engage the first crash beam member such that the first and second roller-hub assemblies provide cantilever support for the gate panel.

Particular embodiments of the present invention may provide one or more technical advantages. Conventional gates may include gate panels supported by a single gate track located along the ground. The gate panel may ride on the gate track such that the gate panel may be opened (to allow authorized individuals and/or vehicles to cross the boundary) and closed (to prevent unauthorized individuals and/or vehicles from crossing the boundary). Conventional gates, however, may be ineffective in preventing unauthorized individuals from crossing the boundary as they may be susceptible to being breached. For example, an unauthorized individual may drive a vehicle into a gate panel of a conventional gate at high speed. Even if the force resulting from the attempted breach is not great enough to cause the gate panel to fail, the gate panel may be dislodged from the gate track such that the unauthorized individual may pass through the gate.

The crash-resistant gate system of the present invention may include a gate panel including one or more integrated crash beams. The gate system of the present invention may further include one or more posts including one or more roller-hub assemblies, the one or more roller-hub assemblies engaging the one or more crash beams of the gate panel. The roller-hub assemblies may engage the crash beams such that they provide cantilever support for the gate panel while allowing the gate panel to move from an open position to a closed position, and vice versa. In other words, the crash beams may provide additional structural rigidity to the gate panel as well as serving as the “tracks” that permit the gate panel to open and close. Because the tracks (i.e., the crash beams) are integrated into the gate panel itself (rather than along the ground, as in certain conventional gates), the gate panel of the present invention may be less likely to be dislodged as a result of an attempted breach (e.g., by an individual attempting to drive a vehicle through the gate system at high speed). Thus, the gate system of the present invention may be less susceptible to being breached relative to certain conventional gates.

Certain embodiments of the present invention may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIGS. 1A-1E illustrate an example crash-resistant gate system, according to certain embodiments of the present invention;

FIGS. 2A-2C illustrate an alternative example crash-resistant gate system, according to certain embodiments of the present invention;

FIGS. 3A-3B illustrate an example gate locking mechanism of an example crash-resistant gate system, according to certain embodiments of the present invention;

FIGS. 4A-4B illustrate certain details of an example roller-hub assembly, according to certain embodiments of the present invention;

FIG. 5 illustrates an example manual crank assembly, according to certain embodiments of the present invention; and

FIG. 6 illustrates an example method of assembling an example crash-resistant gate system, according to certain embodiments of the present invention.

### DESCRIPTION OF EXAMPLE EMBODIMENTS

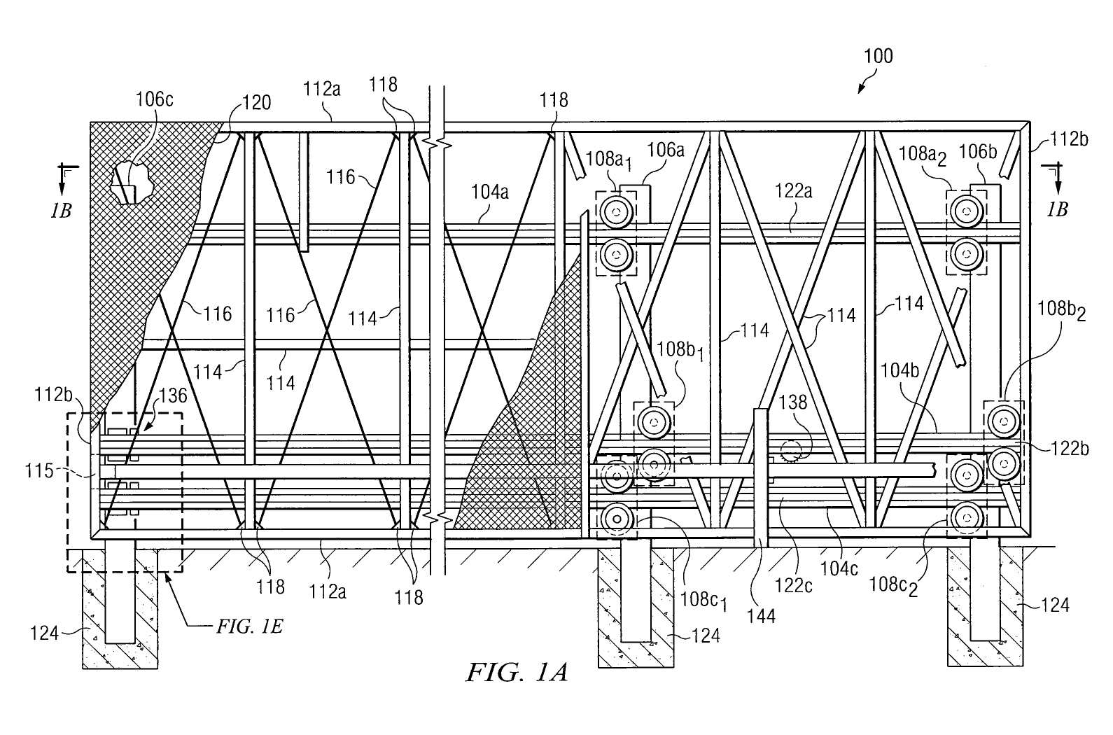

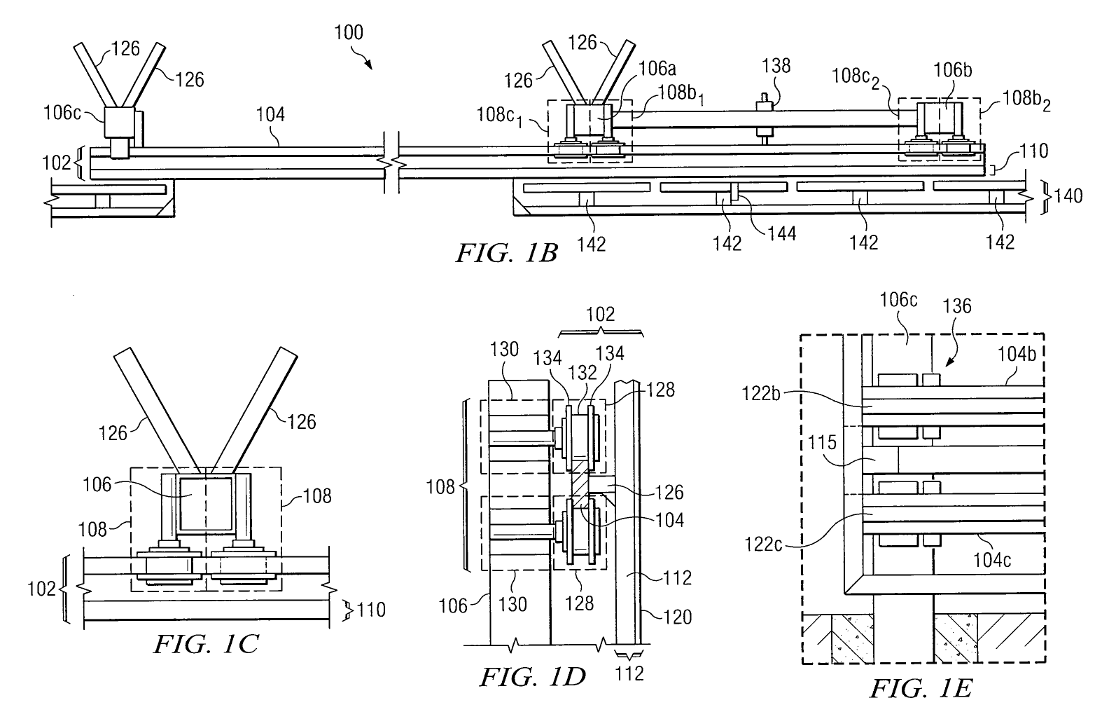

FIGS. 1A-1E illustrate an example crash-resistant gate system 100, according to certain embodiments of the present invention. Gate system 100 may include a gate panel 102 comprising one or more crash beam members 104 (referred to throughout the remainder of this description as crash beams 104 for simplicity). Gate system 100 may further include a number of posts 106. One or more posts 102 may include one or more roller-hub assemblies 108. Each of the one or more roller-hub assemblies may engage one or more crash beams 104 of gate panel 102 such that the one or more roller-hub assemblies 108 provide cantilever support for the gate panel 102.

In general, gate system 100 may deter and/or substantially prevent unauthorized movement across a particular boundary. More particularly, gate system 100 may be integrated into a fence system designed to prevent movement across a boundary such that individuals and/or vehicles that are authorized to cross the boundary may do so while individuals and/or vehicles that are not authorized to cross the boundary are prevented from doing so. Gate system 100 may be integrated into any suitable type of barrier system, such as a fence system. For example, gate system 100 may be a gate for a chain link fence system, a wooden fence system, or any other suitable type of fence system. Example boundaries include perimeters of critical assets, perimeters of privately-owned real estate, national borders, or any other suitable boundaries. Certain individuals (e.g., those who are not authorized to cross the particular boundary) may attempt to breach gate system 100, such as by driving a vehicle into gate panel 102 at high speed. In certain embodiments, because gate panel 102 includes one or more integrated crash beams 104 that serve as the “tracks” that permit gate panel 102 to open and close (e.g., by engaging one or more roller-hub assemblies 108 of one or more posts 106), gate panel 102 may be less likely to be dislodged as a result of an attempted breach (e.g., by an individual attempting to drive a vehicle through the gate system at high speed). Thus, gate system 100 may be less susceptible to being breached relative to certain conventional gates.

Gate panel 102 of gate system 100 may include one or more crash beams 104. Crash beams 104 may be constructed from steel, aluminum, iron, wood, brass, or any other suitable material. Furthermore, crash beams 104 may have any suitable size and shape. For example, crash beams 104 may be constructed from tubing material of any desired cross section (e.g., rectangular, round, elliptical), solid material of any desired cross section (e.g., rectangular, round, elliptical), channel material, angle iron, I-beam, or any other suitable material. Furthermore, crash beams 104 may be any suitable length (e.g., twenty-five, fifty, or seventy-five feet) depending on the width of gate panel 102, which may correspond to the width of the opening gate panel 102 is intended to span (i.e., the width of the gap in the fence system at the point at which gate system 100 is integrated). As a particular example, crash beams 104 may be constructed from a fifty-foot lengths of 8″×3″× 3/16″ steel rectangular tubing. Although gate system 100 is illustrated and primarily described as including a particular number of crash beams 104, the present invention contemplates gate system 100 including any suitable number of crash beams 104, according to particular needs.

Gate panel 102 may further include a gate panel frame 110 including one or more outer frame members 112 and one or more frame cross members 114. Outer frame members 112 may include two horizontal outer frame members 112a attached (e.g., welded, bolted, riveted, screwed, or otherwise attached) at either end to one of two vertical outer frame members 112b, the outer frame members 112 (horizontal outer frame members 112a and vertical outer frame members 112b) defining an outer perimeter of gate panel frame 110 of gate panel 102. Although described as horizontal and vertical, respectively, horizontal outer frame members 112a and vertical outer frame members 112b may have any suitable orientation, according to particular needs. One or more frame cross members 114 may add structural rigidity to the outer perimeter of gate panel frame 110 defined by gate panel outer frame members 112. Frame cross members 114 may include lateral, vertical, and/or diagonal support members attached (e.g., welded, bolted, riveted, screwed, or otherwise attached) to one or more outer frame members 112 and/or one another at any suitable location within gate panel frame 110 of gate panel 102, according to particular needs.

In certain embodiments, one or more shear plates 115 may be attached (e.g., welded, bolted, riveted, screwed, or otherwise attached) to outer frame members 112 and/or frame cross members 114 at the points at which outer frame members 112 are attached frame cross members 114 and/or one another. Shear plates 115 may reinforce the attachment point between two outer frame members 112 and/or attachment point between outer frame members 112 and frame cross members 114 such that gate panel 102 may be less likely to fail due to the force imparted on gate panel 102 resulting from an attempted breach (e.g., by an individual attempting to breach gate system 100 by driving a vehicle or other object into gate system 100 at high speed).

Outer frame members 112 and frame cross members 114 may each be constructed from steel, aluminum, iron, wood, brass, or any other suitable material. Furthermore, outer frame members 112 and frame cross members 114 may each have any suitable size and shape. For example, outer frame members 112 and frame cross members 114 may each be constructed from tubing material of any desired cross section (e.g., rectangular, round, elliptical), solid material of any desired cross section (e.g., rectangular, round, elliptical), channel material, angle iron, I-beam, or any other suitable material. Furthermore, outer frame members 112 and frame cross members 114 may each be any suitable length depending on the size of gate panel 102.

As a particular example, gate panel 110 may include two horizontal outer frame members 112a constructed of a fifty foot length of 4″×4″×¼ square steel tubing attached (e.g., welded, bolted, riveted, screwed, or otherwise attached) at either end to one of two vertical outer frame members 112b constructed of a fifteen foot length of 4″×4″×¼″ steel square tubing (defining an approximately 50′×15′ outer perimeter of gate panel frame 110 of gate panel 102). Additionally, frame cross members 112 may include varying lengths of 3″×4″×¼″ steel rectangular tubing attached (e.g., welded, bolted, riveted, screwed, or otherwise attached) to one or more of outer frame members 112 and/or one another at any suitable location within the outer perimeter defined by outer frame members 112 of gate panel frame 110.

Although gate panel frame 110 of gate panel 102 is illustrated and primarily described as including a particular number outer frame members 112 and frame cross members 114, the present invention contemplates gate panel frame 110 of gate panel 102 including any suitable number of outer frame members 112 and frame cross members 114, according to particular needs.

Gate panel frame 110 of gate panel 102 may further include one or more tensioned cables 116 attached to outer frame members 112 and/or frame cross members 114 at one or more gussets 118, cables 116 adding additional structural rigidity to gate panel frame 110. Cables 116 may be constructed of any suitable material and have any suitable size and shape. For example, cables 118 may be constructed from stainless steel, galvanized steel, aluminum, nylon, brass, or any other suitable material. Furthermore, cables 116 may have any desired cross-sectional shape (e.g., rectangular, round, elliptical) and any suitable diameter/thickness (e.g., ¼ or ½ inch). As a particular example, cables 116 may be constructed of a length of ¼ inch diameter galvanized steel wire rope.

Gate panel frame 110 of gate panel 102 may further include a mesh covering 120. Mesh covering 120 may be attached (e.g., welded, bolted, riveted, screwed, or otherwise attached) to one or more outer frame members 112 and/or one or more frame cross members 114 of gate panel frame 110 and may cover all or a portion of gate panel frame 110. Mesh covering 120 may substantially prevent the passage of individuals and/or objects between the outer frame members 112, frame cross members 114, and/or cables 116 of gate panel frame 110. Mesh covering 120 may be constructed form steel, aluminum, iron, brass, or any other suitable material. Furthermore, mesh covering 120 may be constructed in any suitable configuration designed to, for example, prevent the passage of individuals and/or objects between the outer frame members 112, frame cross members 114, and/or cables 116 of gate panel frame 110. For example, mesh covering 120 may include expanded metal, welded wire mesh, woven wire mesh, perforated panels, or steel grates. Any other suitable type of covering of gate panel frame 110, or none at all, may be used.

Crash beams 104 of gate panel 102 may be attached to gate panel frame 110. More particularly, crash beams 104 may be attached (e.g., welded, bolted, riveted, screwed, or otherwise attached) to one or more outer frame members 112 and/or one or more frame cross members 114 of gate panel frame 110. Furthermore, crash beams 104 may be attached to one or more outer frame members 112 and/or one or more frame cross members 114 of gate panel frame 110 such that crash beams 104 are oriented substantially parallel to the lateral frame member 112 defining the outer perimeter of gate panel frame 110.

In certain embodiments, crash beams 104 are attached to outer frame members 112 and/or one or more frame cross members 114 of gate panel frame 110 with one or more frame support members 122. For example, each crash beam 104 may be attached (e.g., welded, bolted, riveted, screwed, or otherwise attached) to one side of a corresponding frame support member 122 running the length of the crash beam 104, the opposing side of the corresponding frame support member 122 being attached (e.g., welded, bolted, riveted, screwed, or otherwise attached) to one or more vertical cross members 114 of gate panel frame 110. Frame support members 122, in addition to serving as an attachment point between crash beams 104 and gate panel frame 110, may serve as spacers defining a gap between crash beams 104 and gate panel frame 110 such that one or more wheel-hub assemblies 108 may engage a crash beam 104 without contacting gate panel frame 110 (as illustrated in FIG. 1D).

Frame support members 122 may be constructed from steel, aluminum, iron, wood, brass, or any other suitable material. Furthermore, frame support members 122 may have any suitable size and shape. For example, frame support members 122 and frame cross members 114 may each be constructed from tubing material of any desired cross section (e.g., rectangular, round, elliptical), solid material of any desired cross section (e.g., rectangular, round, elliptical), channel material, angle iron, I-beam, or any other suitable material.

Posts 106 of gate system 100 may be constructed from steel, aluminum, iron, wood, brass, concrete, or any other suitable material. Furthermore, posts 106 may have any suitable size and shape. For example, posts 106 may be constructed from tubing material of any desired cross section (e.g., rectangular, round, elliptical), solid material of any desired cross section (e.g., rectangular, round, elliptical), channel material, angle iron, I-beam, or any other suitable material. Furthermore, posts 102 may be any suitable length (e.g., four, eight, twelve, or twenty feet). As a particular example, posts 106 may be constructed from a twenty-foot length of 12″×12″×½″ steel tubing. Although gate system 100 is illustrated and primarily described as including a particular number of posts 106, the present invention contemplates gate system 100 including any suitable number of posts 106, according to particular needs.

Posts 106 may be anchored in the ground (e.g., using concrete 124). In certain embodiments, posts 106 are anchored in the ground such that they are substantially vertical (and, as a result, substantially parallel with one another) regardless of ground slope. Furthermore, the distance between any two adjacent posts 106 (e.g., post 106a and post 106b) may be any suitable distance (e.g., ten feet). In certain embodiments, the distance between any two adjacent posts 106 (e.g., post 106a and post 106b) may depend on the size and/or weight of gate panel 102 (as roller-hub assemblies 108 of posts 106a and 106b are adapted to provide cantilever support for gate panel 102, as described below).

Certain posts 106 of gate system 100 (e.g., posts 106b and 106c) may include one or more post-reinforcing members 126. Post-reinforcing members 126 may provide additional bracing to posts 106 and may increase the force the post 106 may withstand (e.g., the force, such as the horizontal force, imparted on gate panel 102 resulting from an individual attempting to breach gate system 100 by driving a vehicle or other object into gate system 100 at high speed).

Certain posts 106 of gate system 100 (e.g., posts 106a and 106b) may include one or more roller-hub assemblies 108. Each roller-hub assembly 108 may engage a crash beam 104 of gate panel 102, each crash beam 104 engaging at least two roller-hub assemblies 108 such that the at least two roller-hub assemblies 108 engaging a crash beam 104 collectively provide cantilever support for gate panel 102 (including the crash beam 104 and gate panel frame 110 to which the crash beam 104 is attached, as described above). For example, roller-hub assembly 108a₁ of post 102a and roller-hub assembly 108a₂ of post 102b may each engage crash beam 104a such that roller-hub assemblies 108a₁ and 108a₂ provide cantilever support for crash beam 104a. Additionally, because crash beam 104a is attached to gate panel frame 110 (as described above), roller-hub assemblies 108a₁ and 108a₂ may additionally provide cantilever support for gate panel frame 110.

Roller-hub assemblies 108 may each include one or more rollers 128, each roller 128 attached (e.g., welded, bolted, riveted, screwed, or otherwise attached) to a corresponding hub 130. Hubs 130 may each comprise a shaft mounted to a post 106 such that the corresponding roller 128 is permitted to rotate. For example, the shaft of a hub 130 may be mounted to a post 106 using one or more bearings, the bearings permitting the shaft of the hub 130 (as well as the corresponding roller 128 attached to the hub 130) to rotate. Because the one or more rollers 128 of a roller-hub assembly 108 are permitted to rotate, a crash beam 104 engaged by the roller-hub assembly 108 may be permitted to translate substantially laterally (permitting gate panel 102 to move from a closes position to an open position, and vice versa). In other words, the “tracks” that permit gate panel 102 to open and close (i.e., crash beams 104) may be integrated into gate panel 102a, rather than located along the ground as with certain convention gates.

Rollers 128 may be constructed from steel, aluminum, iron, brass, or any other suitable material. Furthermore, rollers 128 may have any suitable size and shape for engaging a crash beam 104 of gate panel 102 such that the crash beam 104 (and gate panel frame 110 to which the crash beams 104 are attached) is able to translate substantially laterally (i.e., gate panel 102 is open and close). In other words, the size and shape of rollers 128 of a roller-hub assembly 108 may depend on the size and shape of the crash beam 104 that the roller-hub assembly 108 engages.

As a particular example (as illustrated in FIG. 1D), a crash beam 104 may be constructed of a length 8″×3″× 3/16″ steel rectangular tubing (as described above). In order to engage a 3″ wide surface of crash beam 104 (i.e., the top or bottom of crash beam 104), one or more rollers 128 of a roller-hub assembly 108 engaging the crash beam 104 may each comprise a cylinder having an outer surface 132 approximately 3″ in width and lips 134 extending outwardly on either side of outer surface 132. Outer surface 132 of a roller 128 may engage a 3″ wide outer surface of the crash beam 104 (either the top or bottom surface of crash beam 104) and lips 134 may maintain alignment between the roller 128 and the crash beam 104 as roller 128 rotates, permitting crash beam 104 to translate laterally (i.e., allowing gate panel 102 to open and close).

As an additional particular example, a crash beam 104 may have a number of gear teeth defined on one or more surfaces of the crash beam 104. In order to engage the gear teeth defined on a particular surface of crash beam 104 (e.g., the top or bottom of crash beam 104), a roller 128 of a roller-hub assembly 108 engaging the particular surface of the crash beam 104 may comprise gear teeth extending outwardly such that the gear teeth of the roller 128 engage corresponding gear teeth defined on the particular surface of crash beam 104. The corresponding sets of gear teeth may maintain alignment between the roller 128 and the crash beam 104 as roller 128 rotates, permitting crash beam 104 to translate laterally (i.e., allowing gate panel 102 to open and close).

Although particular rollers having a particular configuration are illustrated and primarily described, the present invention contemplates any suitable rollers having any suitable configurations, according to particular needs.

Roller-hub assemblies 108 may each comprise any suitable number of rollers 128 and corresponding hubs 130. For example, one or more roller-hub assemblies 108 may include two rollers 128 each having corresponding hubs mounted to a post 106 such that the two rollers 128 may engage opposing surfaces of a crash beam 104. As an additional example, one or more roller-hub assemblies 108 may include a single roller 128 having a corresponding hub 130 mounted to a post 106 such that the roller 128 may engage a single surface of a crash beam 104.

Certain posts 102 of gate system 100 (e.g., post 106c) may include a gate catch member 136. Gate catch member 136 may be configured to engage the one or more crash beams 104 of gate panel 102 when the gate panel 102 is in the closed position. Thus, gate catch member 136 may provide vertical support for gate panel 102 when gate panel 102 is in the closed position. As a result, gate catch member 136 may reduce stress on the one the roller-hub assemblies 108 engaging each crash beam 108 and providing cantilever support for each crash beam 108 when gate panel 102 is in the closed position.

In certain embodiments, gate system 100 may include a gate opening/closing mechanism 138. Gate opening/closing mechanism 138 may include any mechanism operable to provide a substantially lateral force to gate panel 102, which may cause gate panel 102 to translate laterally from the closed position to the open position, and vice versa. In certain embodiments, gate opening/closing mechanism 138 may be manually powered (e.g., by a manual hand crank assembly, as described in further detail below with regard to FIG. 5). In certain other embodiments, gate opening/closing mechanism 138 may be electrically powered (e.g., by an eclectic motor).

In certain embodiments, gate system 100 may be integrated into a fence system 140 having one or more fence posts 142 (illustrated in FIG. 1B) using a gate system attachment member 144. For example, a portion of fence system 140 may overlap a portion of gate system 100, and gate system attachment member 144 may be attached (e.g., welded, bolted, riveted, screwed, or otherwise attached) to both gate system 100 and one or more fence posts 142 of existing fence system 140.

Although a particular implementation of gate system 100 is illustrated and primarily described, the present invention contemplates any suitable implementation of gate system 100 according to particular needs. Although a particular number of components of gate system 100 have been illustrated and primarily described above, the present invention contemplates gate system 100 including any suitable number of such components.

Particular embodiments of the present invention may provide one or more technical advantages. Conventional gates may include gate panels supported by a single gate track located along the ground. The gate panel may ride on the gate track such that the gate panel may be opened (to allow authorized individuals and/or vehicles to cross the boundary) and closed (to prevent unauthorized individuals and/or vehicles from crossing the boundary). Conventional gates, however, may be ineffective in preventing unauthorized individuals from crossing the boundary as they may be susceptible to being breached. For example, an unauthorized individual may drive a vehicle into the gate panel of a conventional gate at high speed. Even if the force resulting from the attempted breach is not great enough to cause the gate panel itself to fail, the gate panel may be dislodged from the gate track such that the unauthorized individual may pass through the gate.

Gate system 100 may include a gate panel 102 including one or more integrated crash beams 104. Gate system 100 may further include one or more posts 106 including one or more roller-hub assembled 108, the one or more roller-hub assemblies 108 engaging the one or more crash beams 104 of the gate panel 102. The roller-hub assemblies 108 may engage crash beams 104 such that roller-hub assemblies 108 provide cantilever support for gate panel 102 while allowing gate panel 102 to move from an open position to a closed position, and vice versa. In other words, crash beams 104 may provide additional structural rigidity to gate panel 102 as well as serving as the “tracks” that permit the gate panel 102 to open and close. Because the tracks (i.e., crash beams 104) are integrated into the gate panel 102 itself (rather than along the ground, as in certain conventional gates), gate panel 102 may be less likely to be dislodged as a result of an attempted breach (e.g., by an individual attempting to drive a vehicle through the gate system at high speed). Thus, gate system 100 may be less susceptible to being breached relative to certain conventional gates.

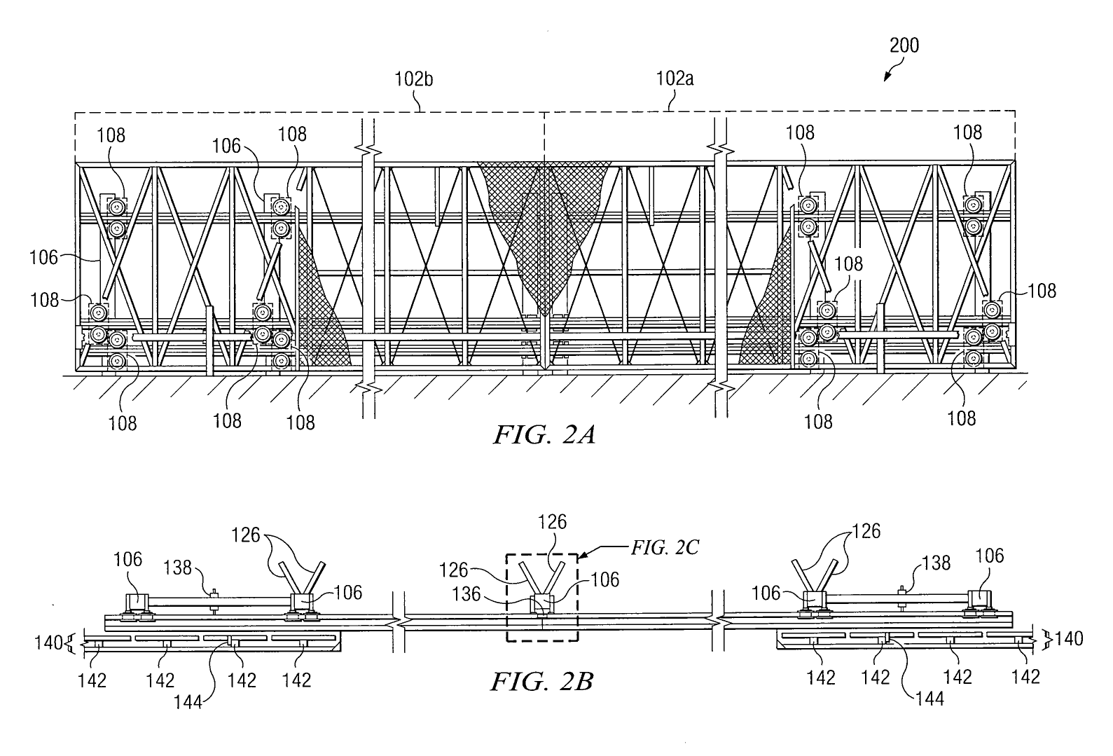

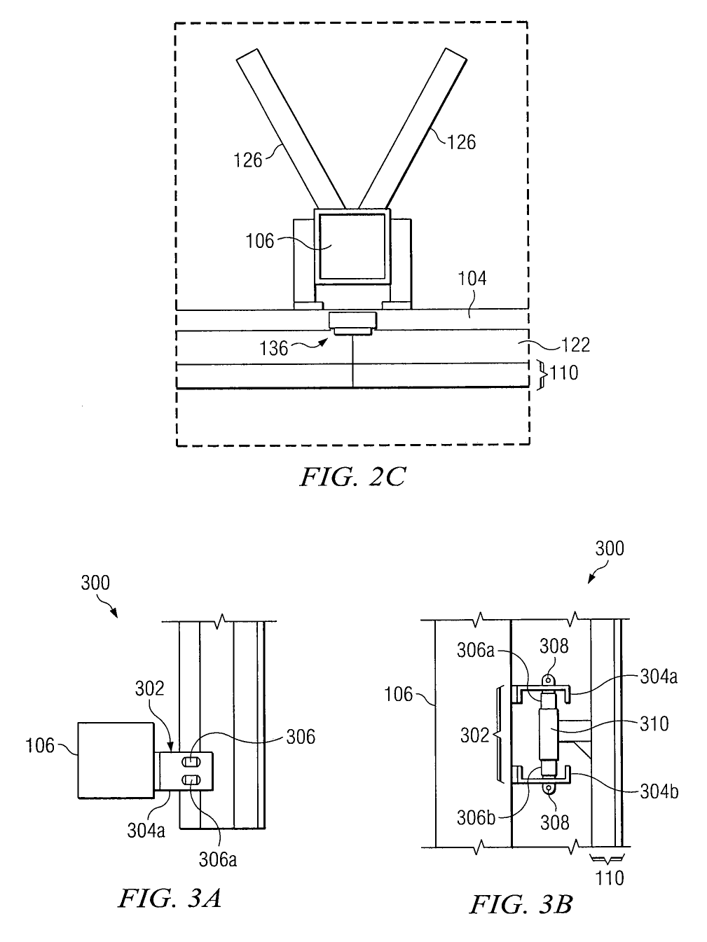

FIGS. 2A-2C illustrate an alternative example crash-resistant gate system 200, according to certain embodiments of the present invention. Crash-resistant gate system 200 may include a first gate panel 102a and a second gate panel 102b, gate panels 102a and 102b each configured substantially similar to gate panel 102, described above with regard to FIGS. 1A-1E. One or more roller-hub assemblies 108 of one or more posts 106 may engage one or more crash beams 104 of gate panels 102a and 102b such that cantilever support is provided for gate panels 102a and 102b (as described above with regard to FIGS. 1A-1E). Furthermore, the one or more roller-hub assemblies 108 of the one or more posts 106 may engage one or more crash beams 104 of gate panels 102a and 102b such that gate panels 102a and 102b are permitted to translate substantially laterally (in opposite directions) from a closed position to an open position, and vice versa (as described above with regard to FIGS. 1A-1E).

FIGS. 3A-3B illustrate an example gate locking mechanism 300 of an example crash-resistant gate system, according to certain embodiments of the present invention. The illustrated gate locking mechanism 300 may be integrated in a substantially similar manner into either example crash-resistant gate system 100 (described above with regard to FIGS. 1A-1E) or crash-resistant gate system 200 (described above with regard to FIGS. 2A-2C), or any other suitable gate system, as described below.

Locking mechanism 300 may include a latch component 302 and one or more receiver components 304. Latch component 302 may be attached (e.g., welded, bolted, riveted, screwed, or otherwise attached) to one or more outer frame members 112 and/or one or more frame cross members 114 of gate panel frame 110.

Latch component 302 may include one or more latch members 306 each having an aperture 308. In certain embodiments, latch component 302 may include four latch members 306 each oriented substantially laterally, two latch members 306 oriented in one direction and two latch members 306 oriented in the opposite direction (i.e., latch component 302 may include two pair of opposing latch members 306). Additionally, each latch member 306 may reside in a housing 310, each latch member 306 coupled to the housing 310 with a spring member. Upon application of a force to opposing ends of opposing latch members 306 (e.g., latch members 306a and 306b), the spring members coupling the opposing latch members to housing 310 may be compressed such that distance between the opposing ends of the opposing latch members is decreased (as each opposing latch member 306 retracts inwardly into housing 310).

Receiver components 304 may be attached (e.g., welded, bolted, riveted, screwed, or otherwise attached) to a post 102 at a location corresponding to the location of latch component 302 on gate panel 102 when gate panel 102 is in the closed position. More particularly, a first receiver component 304a having a number of apertures 312 (each corresponding to a latch member 306) may be attached to a post 102 at a first location and a second receiver component 304b having a number of apertures 312 (each corresponding to a latch member 306) may be attached to a post 102 at a second location. The distance between the first location and the second location may be greater than the distance between opposing latch members 306 when in a compressed position (i.e., when a force is being applied to opposing ends of opposing latch members 306) but less than the distance between opposing ends of opposing latch members 306 when in an extended position (i.e., when no force is being applied to opposing ends of opposing latch members 306). As a result, when in the extended position, opposing latch members 306 may pass through corresponding apertures 312 in receiver components 304a and 304b.

By applying a force to opposing ends of opposing latch members 306 as gate panel 102 is moved to a closed position, the opposing latch members 306 may pass through the space between opposing receiver components 304a and 304b. When gate panel 102 reaches the closed position, the force applied to the opposing ends of opposing latch members 306 may be removed such that the opposing latch members 306 may return to the extended position, the opposing ends of the opposing latch members 306 passing through corresponding apertures 312 of receiver components 304a and 306b. A lock (e.g., a pad lock) may then be placed through one or more apertures 308 of one or more latch members 306 such that gate panel 102 is prevented from moving from the closed position.

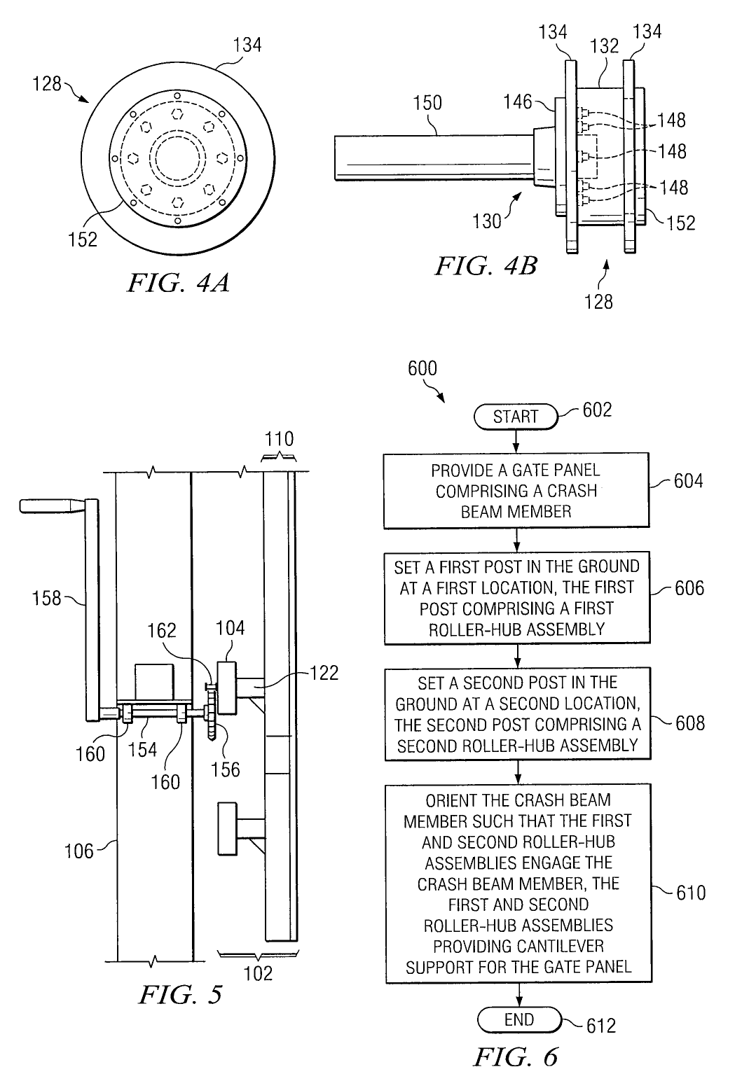

FIGS. 4A-4B illustrate certain details of an example roller-hub assembly 108, according to certain embodiments of the present invention. In the illustrated example, roller-hub assembly 108 includes a roller 128 and a hub 130. Roller 128 may comprise a cylinder having an outer surface 132 and lips 134 extending outwardly on either side of outer surface 132. As a particular example, roller 128 may be constructed from a length of 10¾″ SCH 40 pipe (defining outer surface 132), and lips 132 may be constructed on ½″ steel plate attached (e.g., welded) on either side of outer surface 132. Furthermore, the width of outer surface 132 (i.e., the width between lips 134) may correspond to the width of the surface of a crash beam 104 that the roller 128 is designed to engage.

Hub 130 may include an attachment plate 146, roller 128 being attached to attachment plate 146 of hub 130 with one or more bolts 148. Hub 130 may also include a shaft 150. Shaft 150 may be mounted to a post 106 such that roller 128 is permitted to rotate. For example, shaft 150 of a hub 130 may be mounted to a post 106 using one or more bearings, the bearings permitting shaft 150 of the hub 130 (as well as roller 128 attached to attachment plate 146 of hub 130) to rotate.

Roller-hub assembly 108 may also include a cover plate 152 attached (e.g., welded, bolted, riveted, screwed, or otherwise attached) to roller 128. Cover plate 152 may prevent removal of bolts 148 attaching roller 128 to attachment plate 146 of hub 130.

FIG. 5 illustrates an example manual crank assembly 500, according to certain embodiments of the present invention. As described above with regard to FIGS. 1A-1E, gate system 100 may include a gate opening/closing mechanism 138 operable to provide a substantially lateral force to gate panel 102, which may cause gate panel 102 to translate laterally from the closed position to the open position, and vice versa. Manual crank assembly 500 is one example of a gate opening/closing mechanism 138 of gate system 100.

Manual crank assembly 500 may include a crank assembly shaft 154 having a sprocket 156 attached (e.g., welded, bolted, riveted, screwed, or otherwise attached) at one end crank handle 158 removably attached at the opposing end. Crank assembly shaft 154 may be mounted to a post 106 (e.g., post 106a, 106b, or 106c illustrated in FIGS. 1A-1E or an additional post 106 not illustrated in FIGS. 1A-1E) using one or more bearings 160, bearings 160 permitting crank assembly shaft 154 to rotate.

Sprocket 156 may have a number of gear teeth and may be oriented such that the gear teeth engage a portion of a chain attached (e.g., welded, bolted, riveted, screwed, or otherwise attached) to the inside of a channel 162. Channel 162 may be attached (e.g., welded, bolted, riveted, screwed, or otherwise attached) along all or a portion of the length of a surface of crash beam 104.

Thus, manually turning crank handle 158 may cause crank assembly shaft 154 to rotate, which causes sprocket 156 to rotate. As sprocket 156 rotates, the gear teeth of sprocket 156 may engage the chain attached to the inside of a channel 162. As the gear teeth engage the chain, sprocket 156 may impart a substantially lateral force to gate panel 102 (via the crash beam 104 to which channel 156 is attached), which may cause gate panel 102 to translate laterally from the closed position to the open position, and vice versa.

FIG. 6 illustrates an example method 600 of assembling an example crash-resistant gate system, according to certain embodiments of the present invention. The method begins at step 602. At step 604, a gate panel 102 may be provided that includes a crash beam member 104 (e.g., crash beam member 104a). The gate panel 102 may further include a gate panel frame 110 including one or more outer frame members 112, one or more frame cross members 114, and a mesh covering 120. Mesh covering 120 may be attached (e.g., welded, bolted, riveted, screwed, or otherwise attached) to one or more outer frame members 112 and/or one or more frame cross members 114 of gate panel frame 110 and may cover all or a portion of gate panel frame 110. Furthermore, the crash beam 104 may be attached to outer frame members 112 and/or one or more frame cross members 114 of gate panel frame 110 using one or frame support members 122. For example, crash beam 104 may be attached (e.g., welded, bolted, riveted, screwed, or otherwise attached) to one side of a frame support member 122 running the length of the crash beam 104, the opposing side of the support member 122 being attached (e.g., welded, bolted, riveted, screwed, or otherwise attached) to one or more vertical cross members 114 of gate panel frame 110.

At step 606, a first post 106 may set in the ground at a first location, the first post 106 (e.g., post 106a) comprising a first roller-hub assembly 108 (e.g., roller-hub assembly 108a₁). At step 608, a second post 106 may be set in the ground at a second location, the second post 106 (e.g., post 106b) comprising a second roller-hub assembly 108 (e.g., roller-hub assembly 108a₂). First and second roller-hub assemblies 108 (e.g., roller-hub assemblies 108a₁ and 108a₂) may each include one or more rollers 128. Rollers 128 may have any suitable size and shape such that the rollers 128 may engage the crash beam 104. In other words, the size and shape of rollers 128 of roller-hub assemblies 108a₁ and 108a₂ may depend on the size and shape of the crash beam 104. Furthermore, each roller 128 may be attached (e.g., welded, bolted, riveted, screwed, or otherwise attached) to a corresponding hub 130. Hubs 130 may each comprise a shaft mounted to a post 106 (e.g., posts 106a and 106b) such that the corresponding roller 128 is permitted to rotate.

At step 610, the crash beam 104a may be oriented such that the first roller-hub assembly 108a₁ and the second roller-hub assembly 108a₂ engage the crash beam member 104a, the first roller-hub assembly 108a₁ and the second roller-hub assembly 108a₂ providing cantilever support for gate panel 102. Additionally, because rollers 128 of a roller-hub assemblies 108a₁ and 108a₂ are permitted to rotate (as described above), crash beam 104a may be permitted to translate substantially laterally (permitting gate panel 102 to move from a closes position to an open position, and vice versa). In other words, the track that permits gate panel 102 to open and close (i.e., crash beam 104a) may be integrated into gate panel 102a, rather than located along the ground as in certain convention gates. At step 612, the method may end.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A gate system, comprising:
a gate panel comprising a first crash beam member;
a first post comprising a first roller-hub assembly; and
a second post comprising a second roller-hub assembly;
the first and second roller-hub assemblies engaging the first crash beam member such that the first and second roller-hub assemblies provide cantilever support for the gate panel.

2. The system of claim 1, wherein the first and second roller-hub assemblies engage the first crash beam member such that the gate panel is permitted to translate substantially laterally between an open position and a closed position.

3. The system of claim 2, comprising a third post comprising a gate catch member, the gate catch member configured to engage the first crash beam member such that the gate catch member provides vertical support for the gate panel when the gate panel is in the closed position.

4. The system of claim 2, comprising a gate opening/closing mechanism configured to provide a substantially lateral force to the gate panel such that gate panel translates laterally from the closed position to the open position.

5. The system of claim 1, wherein the gate panel further comprises a gate panel frame and a frame support member, the crash beam member attached to the gate panel frame with the frame support member.

6. The system of claim 1, wherein:
the first roller-hub assembly comprises a first roller;
the second roller-hub assembly comprises a second roller; and
the first and second roller-hub assemblies engage the first crash beam member such that the first roller engages a first surface of the first crash beam member and the second roller engages a second surface of the first crash beam member.

7. The system of claim 1, wherein:
the first crash beam member comprises a first surface and a second surface;
the first roller-hub assembly comprises a first roller and a second roller;
the second roller-hub assembly comprises a third roller and a fourth roller;
the first and second roller-hub assemblies engage the crash beam member such that the first and third rollers engage a first surface of the first crash beam member and the second and fourth rollers engage a second surface of the first crash beam member.

8. The system of claim 1, wherein:
the gate panel further comprises a second crash beam member;
the first post further comprises a third roller-hub assembly;
the second post further comprises a fourth roller-hub assembly;
the third and fourth roller-hub assemblies engaging the second crash beam member such that the third and fourth roller-hub assemblies provide cantilever support for the gate panel.

9. The system of claim 8, wherein:
the first roller-hub assembly comprises a first roller;
the second roller-hub assembly comprises a second roller;
the third roller-hub assembly comprises a third roller;
the fourth roller-hub assembly comprises a fourth roller;
the first and second roller-hub assemblies engage the first crash beam member such that the first roller engages a first surface of the first crash beam member and the second roller engages a second surface of the first crash beam member; and
the third and fourth roller-hub assemblies engage the second crash beam member such that the third roller engages a first surface of the second crash beam member and the fourth roller engages a second surface of the second crash beam member.

10. The system of claim 1, wherein:
the gate panel further comprises a second crash beam member and a third crash beam member;
the first post further comprises a third roller-hub assembly and a fourth roller-hub assembly;
the second post further comprises a fifth roller-hub assembly and a sixth roller-hub assembly;
the third and fifth roller-hub assemblies engaging the second crash beam member such that the third and fifth roller-hub assemblies provide cantilever support for the gate panel; and
the fourth and sixth roller-hub assemblies engaging the third crash beam member such that the fourth and sixth roller-hub assemblies provide cantilever support for the gate panel.

11. The system of claim 10, wherein
the first roller-hub assembly comprises a first roller;
the second roller-hub assembly comprises a second roller;
the third roller-hub assembly comprises a third roller;
the fourth roller-hub assembly comprises a fourth roller;
the fifth roller-hub assembly comprises a fifth roller;
the sixth roller-hub assembly comprises a sixth roller;
the first and second roller-hub assemblies engage the first crash beam member such that the first roller engages a first surface of the first crash beam member and the second roller engages a second surface of the first crash beam member;
the third and fifth roller-hub assemblies engage the second crash beam member such that the third roller engages a first surface of the second crash beam member and the fifth roller engages a second surface of the second crash beam member; and
the fourth and sixth roller-hub assemblies engage the third crash beam member such that the fourth roller engages a first surface of the third crash beam member and the sixth roller engages a second surface of the third crash beam member.

12. A method of assembling a gate system, comprising:
providing a gate panel comprising a crash beam member;
setting a first post in the ground at a first location, the first post comprising a first roller-hub assembly;
setting a second post in the ground at a second location, the second post comprising a second roller-hub assembly; and
orienting the crash beam member such that the first and second roller-hub assemblies engage the crash beam member, the first and second roller-hub assemblies providing cantilever support for the gate panel.

13. The method of claim 12, wherein the first and second roller-hub assemblies engage the crash beam member such that the gate panel is permitted to translate substantially laterally between an open position and a closed position.

14. The method of claim 13, comprising setting a third post in the ground at a third location, the third post comprising a gate catch member configured to engage the crash beam member such that the gate catch member provides vertical support for the gate panel when in the closed position.

15. The method of claim 13, comprising providing a gate opening/closing mechanism configured to provide a substantially lateral force to the gate panel such that gate panel translates laterally from the closed position to the open position.

16. The method of claim 12, wherein the gate panel further comprises a gate panel frame and a frame support member, the crash beam member attached to the gate panel frame with the frame support member.

17. The method of claim 12, wherein:
the first roller-hub assembly comprises a first roller;
the second roller-hub assembly comprises a second roller; and
the first and second roller-hub assemblies engage the crash beam member such that the first roller engages a first surface of the crash beam member and the second roller engages a second surface of the crash beam member.

18. The method of claim 12, wherein:
the first roller-hub assembly comprises a first roller and a second roller;
the second roller-hub assembly comprises a third roller and a fourth roller; and
the first and second roller-hub assemblies engage the crash beam member such that the first and third rollers engage a first surface of the crash beam member and the second and fourth rollers engage a second surface of the crash beam member.

19. A gate system, comprising:
a gate panel comprising a first crash beam member and a second crash beam member;
a first post comprising a first roller-hub assembly comprising a first roller and a second roller a second roller-hub assembly comprising a third roller and a fourth roller; and
a second post comprising a third roller-hub assembly comprising a fifth roller and a sixth roller and a fourth roller-hub assembly comprising a seventh roller and an eight roller;
the first and third roller-hub assemblies engaging the first crash beam member such that the first and third roller-hub assemblies provide cantilever support for the gate panel, the first and third rollers engaging a first surface of the first crash beam member and the second and fourth rollers engaging a second surface of the first crash beam member;
the second and fourth roller-hub assemblies engaging the third crash beam member such that the fourth and sixth roller-hub assemblies provide cantilever support for the gate panel, the fifth and seventh rollers engaging a first surface of the second crash beam member and the sixth and eighth rollers engaging a second surface of the second crash beam member; and
the first and third roller-hub assemblies engaging the first crash beam member and the second and fourth roller-hub assemblies engaging the third crash beam member such that the gate panel is permitted to translate substantially laterally between an open position and a closed position.

20. The system of claim 18, comprising a third post comprising a gate catch member, the gate catch member configured to engage the first and second crash beam member such that the gate catch member provides vertical support for the gate panel when the gate panel is in the closed position.
